(19) United States
(12) Patent Application Publication
(10) Pub. No.: US 2022/0152619 A1
(43) Pub. Date: May 19, 2022

(54) ABRASION RESISTANT WEAR PART FOR VSI CRUSHER ROTOR

(71) Applicant: SANDVIK SRP AB, Svedala (SE)

(72) Inventors: Andreas FORSBERG, Malmo (SE); Knut KJAERRAN, Svedala (SE); Rowan DALLIMORE, Somerset (GB)

(21) Appl. No.: 17/440,404

(22) PCT Filed: Mar. 19, 2019
(86) PCT No.: PCT/EP2019/056871

§ 371 Date: Sep. 17, 2021

(51) Int. Cl. B02C 13/28; B02C 13/18

(52) U.S. Cl. CPC B02C 13/2804; B02C 2210/02; B02C 13/1835

(57) ABSTRACT

An abrasion wear resistant plate mountable to a rotor of a vertical shaft impact crusher includes a metallic main body, and at least four non-metallic tiles arranged on an upper surface of the main body to form a portion of a contact face facing an internal space of the rotor. Each of the tiles have an abrasion wear resistance greater than that of the main body, each one of the tiles having at least three edges each matching with and positioned against an edge of a neighboring tile.

### FIELD OF INVENTION

The present invention relates to an abrasion wear resistant plate mountable to protect a rotor within a vertical shaft impact crusher from material fed into the rotor.

### BACKGROUND ART

Vertical shaft impact (VSI) crushers find widespread use for crushing a variety of hard and abrasive materials, such as rock, ore, demolished constructional materials, industrial minerals and the like. Typically, a VSI crusher comprises a housing that accommodates a horizontally aligned rotor mounted at a generally vertically extending main shaft. The rotor is provided with a top aperture through which material to be crushed is fed under gravity from an elevated position. The centrifugal forces of the spinning rotor eject the material against a wall of compacted feed material or specifically a plurality of anvils or retained material such that on impact with the anvils and/or the retained material the feed material is crushed to a desired size.

The rotor commonly comprises a horizontal upper disc and a horizontal lower disc. The upper and lower discs are connected and separated axially by a plurality of upstanding rotor wall sections. The top aperture is formed within the upper disc such that the material flows downwardly towards the lower disc between the wall sections and is then ejected at high speed towards the anvils.

As will be appreciated, due to the abrasive nature of the crushable material, the distributor plate and the surrounding wear plates (that sit radially outside distributor plate and are mounted to both the upper and lower rotor discs) are subject to substantial abrasive wear which significantly reduces their operational lifetime and increases the frequency of servicing intervals. Accordingly, it is a general objective to maximise the operational lifetime of the plates. US 2003/0213861; US 2004/0251358; WO 2008/087247; WO 2004/020101 and WO 2015/074831 describe wear plates having embedded tungsten carbide inserts exposed at the wear or contact face of the plate. However, conventional plates due to the choice of material of the component parts tend to be thick and heavy which introduces several significant disadvantages. In particular, the upper wear plates are worn by crushable material not under the influence of gravity, but the centrifugal force and spurting movement of material within the rotor. Accordingly, what is required is a wear plate mountable at a VSI crusher rotor that addresses the above problems.

### SUMMARY OF THE INVENTION

It is an objective of the present invention to provide a vertical shaft impact (VSI) crusher wear plate configured to be resistant to the operational abrasive wear due to contact with a flow of crushable material through the crusher rotor. It is a further specific objective to maximise the operational lifetime of the wear plate and to minimise, as far as possible, the frequency of maintenance service intervals that would otherwise disrupt the normal operation of the crusher. It is a further specific objective to provide a wear plate that may be conveniently handled during servicing procedures and that may be readily attached and dismounted at the rotor. It is a further specific objective to provide a wear plate with tiles free of metallic component to alleviate metal contamination to the crushable material.

The objectives are achieved, in part, by a selection of constituent materials of the component parts of the plate that provide a compact (thin) and lightweight construction without compromising abrasion wear resistance and the plate operational lifetime. In particular, the wear resistant plate comprises a main body formed from a metallic material and at least four non-metallic insert or tile mounted at the main body to optimise wear resistance and minimise the weight and thickness of the tile. In particular, the non-metallic component is preferably formed from a ceramic that offers high wear resistance for example relative to carbide and has a weight that is less than tungsten carbide. Providing a plate with a component that offers a higher abrasion wear resistance than tungsten carbide provides a plate assembly of reduced thickness without compromising the plate service lifetime. The relatively thinner component parts of the plate are advantageous to adapt the plate to be suitable for a mechanism of attachment to the rotor that offers further advantages regarding ease of attachment and dismounting at the rotor and to optimise the available free volume within the rotor.

According to a first aspect of the present invention there is provided an abrasion wear resistant plate mountable to protect a rotor within a vertical shaft impact crusher from material fed into the rotor comprising: a metallic main body; at least four non-metallic tiles arranged on an upper surface of the main body to form a portion of a contact face to be facing the internal space of the rotor, the tile having an abrasion wear resistance greater than that of the main body; wherein each one of the tiles has at least three edges each matching with and positioned against an edge of a neighbouring tile.

Within the specification the term ‘substantially free’ of tungsten carbide refers to the tile being devoid of tungsten carbide and formed from a non-tungsten carbide material. This term also refers to non-metallic tile configurations in which tungsten carbide is included as an impurity or as a minority component within a composite tile formed from a ceramic or other carbide material (not tungsten based).

Advantageously, the tile is mounted at the main body such that the contact face comprises a combination of an exposed wear surface of the tile and a work surface of the main body, the wear surface being co-aligned with the work surface to form a seemingly continuous single surface to be contacted by the material. Accordingly, the material is capable of flowing over the contact face without being diverted from the intended flow path due to any bulge or recess from the upper surface of the main body. Preferably, the work surface of the main body and the wear surface of the tile are co-planar. Preferably, the contact face is substantially planar.

Preferably, the main body comprises predominantly or substantially exclusively a steel alloy. Preferably, the main body comprises a high abrasion resistant steel such as high carbon steel and the like. Optionally, the main body may comprise nodular iron. Optionally, the main body may comprise carbide granules embedded within the main body matrix in addition to mounting the non-metallic tile. Such an arrangement is advantageous to further extend the plate operational lifetime.

Optionally, the tiles are arranged in the upper surface of the main body such that the combination of the tiles forms a continuous working area being encompassed by the upper surface of the main body. Each one of the tiles has at least six edges each matching with and positioned against an edge of a neighbouring tile. Such an arrangement is advantageous for a tile to pass the impact stress imposed by the material to neighbouring tiles.

Optionally, each one of the tiles has at a shape of hexagon or half-hexagon. A half-hexagon can also be an isosceles trapezoid. Such an arrangement is advantageous that an individual tile can have maximum six neighbouring tiles to disperse and bear the impact stress from the material, while having only limited cost for trimming a tile during manufacturing.

Optionally, the main body has an elongate shape, a front end pointing towards the rotating direction of the rotor and a rear end positioned in the opposite side; and the working area is located closely to the rear end of the main body. Due to the shape and position of the side wall of the rotor, material will likely be stacked at the front end above the main body in many different working conditions. It is advantageous to provide proper protection to the wear plate and saving the costs on the tiles when the working area is placed closely to the rear end of the main body.

Optionally, the continuous working area has substantially a peripheral being mainly rectangularly shaped with two longer sides being parallel. The shape of the main body is advantageous to configure the shape of the working area that can be pieced together by hexagonal or half-hexagonal tiles and covering much of the upper surface of the main body at the rear end.

Optionally, the working area is positioned such that the short sides of the rectangle is parallel with an edge of the rear end of the main body. It is advantageous to machining a recess with regular shape to place the entire working area, and evenly bear the impact stress from the tiles.

Optionally, the main body has a straight side and a curved side, and the continuous working area is positioned such that the two longer sides of the rectangle are parallel with the straight side of the main body and being spaced from the straight side of the main body by a portion of the upper surface of the main body. It is advantageous to place the working area from the straight side of the main body for a distance, as the straight side doesn't need to be protected by tiles. The straight side of the main body is annex to the sidewall and will probably to be covered by retained stationary material.

Optionally, a thickness in a direction perpendicular to the upper surface of the plate assembly is less than 50 mm. Optionally, a thickness of the plate assembly may be in the range 20 to 40 mm and optionally, 28 to 32 mm. Such a configuration is advantageous to maximise the free volume within the rotor and in turn optimise the crushing capacity.

Optionally, the wear resistant plate comprises a plurality of tiles comprising substantially the same size and/or shape. Optionally, the tiles may be formed from abrasion resistant inserts of different shapes and sizes dependent upon their position at the main body relative to the material flow path over the plate.

Optionally, the tile may comprise any one or a combination of aluminium oxide (alumina), zirconium oxide (zirconia), silicon carbide, boron carbide, silicon nitride or boron nitride. Such materials provide a plate that is lightweight (relative to tungsten carbide) and comprises high abrasion resistance to extend the plate operational lifetime and accordingly reduce the frequency of servicing or replacement intervals.

Optionally, the tile may be bonded to the main body via an adhesive. Optionally, the tile may be bonded to the main body via encapsulation of at least part of a perimeter of the tile by the main body during a casting of the plate. Optionally, the tile may be bonded to the main body via an interference tapper or step fit. That is, the tile may comprise tapering side faces configured to engage against tapered sidewalls that define holes within the main body against which the tile is friction mounted. Optionally, the tile may be bonded to main body via mechanical attachments such as pins, screws or weld. Accordingly, the tile is configured to be non-detachably mounted at the main body and to form an integral part of the plate assembly. Optionally, the tile may be bonded to the main body via an intermediate mesh, gauze or other open structure within which the molten material of the main body is capable of flowing during casting of the plate. Optionally, the tiles may be bonded to the main body following casting or machining of the main body.

Optionally, the main body may comprise: a work plate, the tile mounted at the work plate; and a support plate non-detachably coupled to the work plate. Such an arrangement is advantageous to optimise the mechanical and physical characteristics of the work plate to be abrasion resistant whilst minimising the volume of such materials. Optionally, the support plate may be formed from a steel alloy. Optionally, the work plate and support plate are bonded together to form a unified structure by rivet welding, via an adhesive or a combination of both. Optionally, the work plate and support plate may be bonded by mechanical attachments to form a unified structure. Optionally, a thickness of the work plate including the insert may be in the range 10 to 30 mm or optionally 15 to 20 mm. Optionally, a thickness of the support plate may be in the range 5 to 15 mm or optionally 8 to 12 mm.

Optionally, a surface area of the tile at the contact face, or where the wear plate comprises a plurality of tiles the combined surface area of the tiles at the contact face, is less than a surface area of main body at the contact face. Accordingly, the abrasion resistant tiles are, in one aspect, provided at the region of the wear plate over which the majority of the material flows. Accordingly, those regions of the wear plate over which feed material collects as a deposit, void of the abrasion resistant inserts as this region is not susceptible to abrasion wear.

### BRIEF DESCRIPTION OF DRAWINGS

A specific implementation of the present invention will now be described, by way of example only, and with reference to the accompanying drawings in which:

FIG. 1 is an external perspective view of a VSI crusher rotor having upper and lower discs separated by wall sections according to a specific implementation of the present invention;

FIG. 2 is a cross section perspective view from underside of the rotor of FIG. 1 with a portion of the upper disc, a portion of the lower disc and one of the walls and wear plates removed for illustrative purposes;

FIG. 3 is a cross section perspective view from upside of the rotor of FIG. 1 with a portion of the upper disc, a portion of the lower disc and one of the walls and wear plates removed for illustrative purposes;

FIG. 4 is a plan view of the lower disc of the rotor of FIGS. 1 and 2;

FIG. 5 is a further magnified perspective view of the rotor of FIGS. 1 and 2 with the upper disc and one of the walls and wear plates removed for illustrative purposes;

FIG. 6 is an underside perspective view of the distributor plate assembly;

FIG. 7 is an underside perspective view of the wear plate assembly;

FIG. 8 is a cross section view of part of a wear plate assembly according to a further specific implementation of the present invention;

### DETAILED DESCRIPTION OF PREFERRED EMBODIMENT OF THE INVENTION

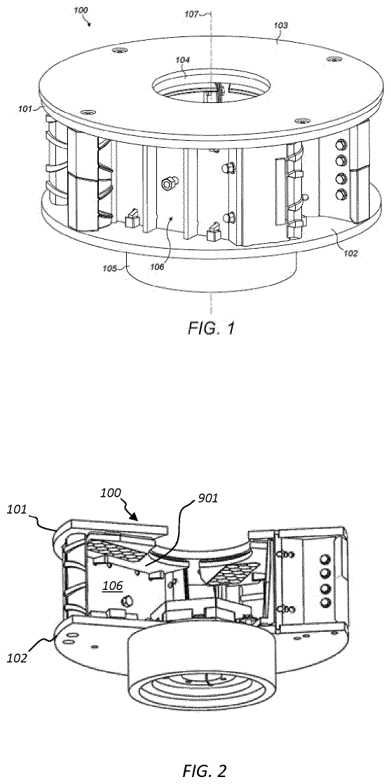

Referring to FIG. 1, a rotor 100 of a vertical shaft impact (VSI) crusher comprises a roof in the form of an upper horizontal disc 101 having an upper wear plate 103, and a floor in the form of a lower horizontal disc 102. The upper and lower discs 101, 102 are separated by walls 106 that channel the flow of material passing through rotor 100. The lower disc 102 is welded to a hub 105 that is in turn connected to a vertical shaft (not shown) for rotating rotor 100 within a main housing (not shown) of the VSI-crusher. Upper disc 101 has a central aperture 104 through which material to be crushed may be fed into rotor 100. Upper horizontal disc 101 is protected from crushable material impacting the rotor 100 from above by a top wear plate 103.

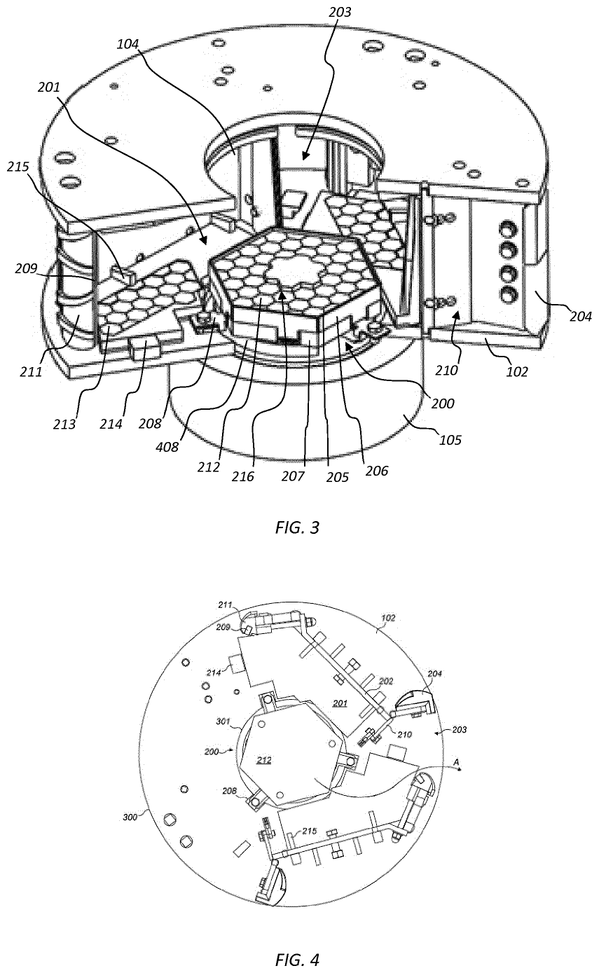

FIG. 2 illustrates rotor 100 with part of upper disc 101 and part of wall 106 removed for illustrative purposes. Both the upper and lower discs 101, 102 are protected from wear by three wear plates 201, 901 (only two wear plates 901 are illustrated on upper disc 101). As shown in FIG. 3, the distributor plate 200 is mounted centrally above hub 105 so as to be elevated above lower disc 102. Plate 200 is configured to distribute the feed material received through aperture 104 and to protect lower disc 102 from wear and impact damage caused by the abrasive contact with the feed material. Distributor plate 200 is modular in the axial direction and comprises three vertically stacked plates including in particular a uppermost work plate 205, an intermediate support plate 206 and lowermost spacer plate 207. Plate 207 is attached directly to a base plate 408 that is secured directly to an uppermost end of hub 105 to provide an indirect mount of support plate 206 and work plate 205 at rotor 100. Work plate 205 comprises a hexagonal main body within which is mounted abrasion wear resistant inserts 213 in the form of hexagonal or half-hexagonal tiles. It shall be understood by the person of ordinary skill in the art that half-hexagonal tiles refer to convex isosceles trapezoids, and the base line of the convex isosceles trapezoids is formed from the diagonal of a hexagon. It shall be understood by people of ordinary skill in the art that abrasion wear resistance refers to the ability of materials and structures to withstand mechanical wear caused by a crushable material, for example, high surface hardness and relatively high toughness.

Accordingly, a contact face 216 of distributor plate 200 is defined by the combination of an uppermost surface of work plate 205 and corresponding uppermost surfaces of each wear resistant tile 212. Distributor plate 200 is releasably mounted at rotor 100 (via base plate 408) by a plurality of attachment components indicated generally by reference 208. Components 208 are positioned at and around an outside perimeter of distributor plate 200 and provide exclusively a mechanism for attaching plate 200 to the rotor 100 and in particular hub 105.

Lower wear plates 201 are positioned to at least partially surround the perimeter of distributor plate 200 and at least partially cover an exposed surface of lower disc 102 from abrasive wear. Referring to FIG. 3, each lower wear plate 201 is positioned radially adjacent to an outer perimeter of disc 102 that is generally annular and comprises a circular central opening positioned approximately at the perimeter of distributor plate 200. Each lower wear plate 201 is generally elongate and extends in a part circumferential path around annular disc 102 so as to provide a wear surface over which material may flow in a radially outward direction. To increase the wear resistance, each lower wear plate 201 comprises a plurality of abrasion wear resistant inserts 213. Like distributor plate inserts 212, wear plate inserts 213 are in the shape of hexagonal or half-hexagonal as an isosceles trapezoid formed from a non-metallic material such as a ceramic.

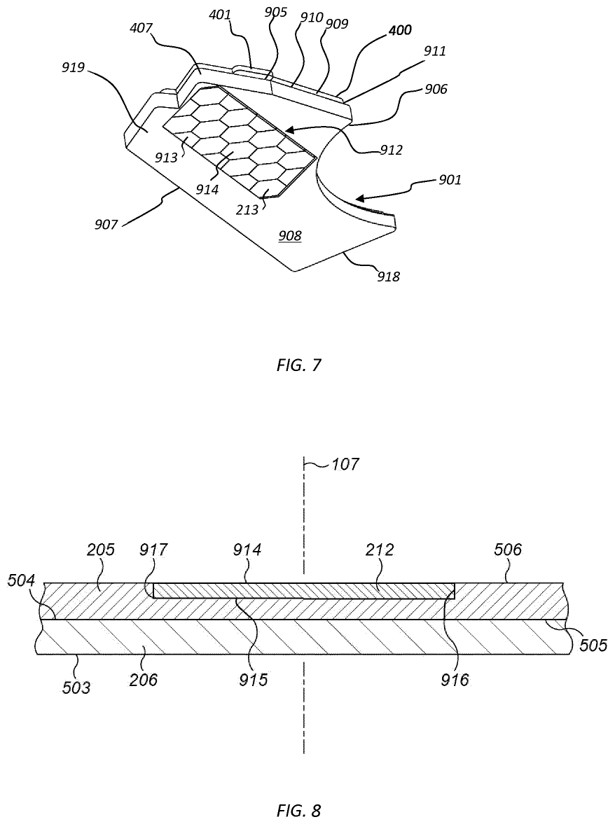

Similar to upper wear plate 901, referring to FIG. 5, each lower plate 201 comprises a dual layer structure having a work plate 407 that mounts inserts 213 and a support plate 400 positioned axially intermediate work plate 407 and disc 102. According to the specific implementation, tiles 212, 213 comprise a non-tungsten carbide such as silicon carbide whilst the main body of plates 205, 201 are formed from a metal alloy, typically steel. As shown in FIG. 3, a wall section 202 extends vertically upward from lower disc 102 and is sandwiched against upper disc 101. Each wall is bordered at a rearward end by rear wall 210. A wear tip shield 204 extends radially outward at the junction of wall section 202 and rear wall 210 to extend vertically upward from disc outer perimeter. An opposite end of wall section 202 is bordered by a holder 211 that mounts respectively an elongate wear tip 209 also aligned perpendicular and extending upwardly from one end of each wear plate 201. Each lower wear plate 201 is maintained in position at lower disc 102 by a right-angle bracket 214 that is configured to engage a step 401 (and in particular a surface 905 of step 401 referring to FIG. 7) projecting from the lengthwise end of each lower wear plate 201. The main length of each lower wear plate 201 is further secured against wall sections 202 via a plurality of wedge-shaped plugs 215 that extend through wall sections 202 and abut onto the upward facing surface of each plate 201.

As indicated in FIG. 3, material passing through rotor 100 is configured to fall onto central distributor plate 200, to be thrown outwardly over lower wear plate 201 in a direction of arrow A and then to exit rotor 100 via outflow openings 203 positioned between each wear tip shield 204 and the corresponding wear tip 209. Wear plates 201 are also secured on an underside surface of upper disc 101 and secured in position by corresponding plugs 215 and brackets 214. Accordingly, and in use, a bed of material is directed to collect between the upper and lower wear plates 201 against wall sections 202.

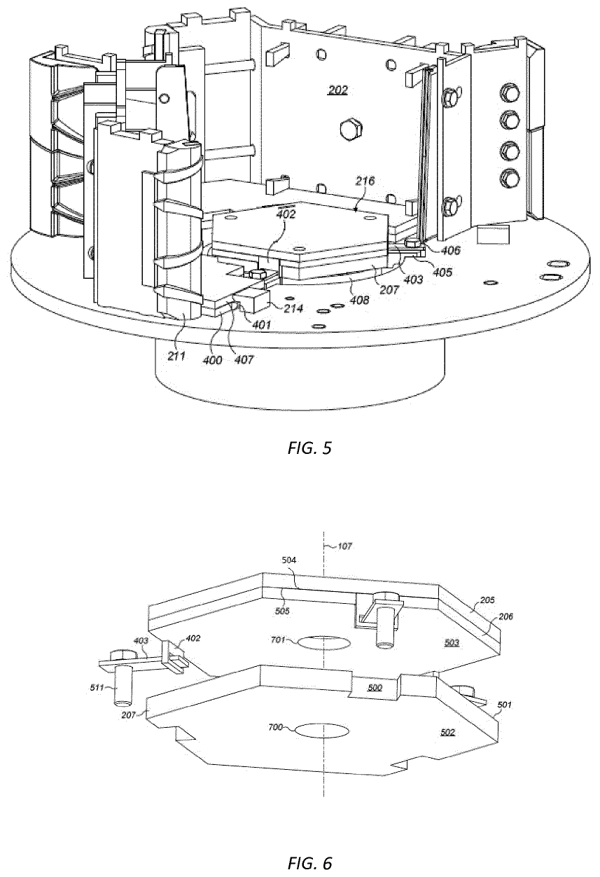

As shown in FIG. 6, support plate 206 is non-detachably coupled to work plate 205 via mating contact between an upward facing surface 504 and support plate 206 and a downward facing planar surface 505 of work plate 205. According to the specific implementation, plates 205, 206 are glued together via an adhesive. According to further specific implementations, work plates 205, 206 may be coupled via mechanical attachments including for example rivet welding, thermal bonding, or other mechanical attachments such as pins, screws or bolts. According to the specific implementation, a thickness of work plate 205 in a direction of axis 107 is in the range 15 to 20 mm whilst a corresponding thickness of support plate 206 is in the range 8 to 12 mm. The optional spacer plate 207 may comprise a thickness in the range 20 to 30 mm. According to one embodiment, as shown in FIG. 3, distributor plate 200 comprises a total thickness in the direction of axis 107 of approximately 30 mm. This lower profile configuration is advantageous to maximize the available (free) volume within rotor 100 between the opposed lower and upper discs 102, 101 so as to maximize the through flow of material and accordingly the capacity of the crusher. The minimized thickness of distributor plate 200 is achieved, in part, by the choice of component materials. In particular, work plate 205 comprises an abrasion resistant metal alloy including for example nodular iron or a high carbon steel. Support plate 206 may comprise a less abrasion resistant steel selected to provide sufficient structural strength whilst being lightweight. Support plate 206 and optionally spacer plate 207 may comprise a solid configuration or may be formed as latticework, honeycomb or may comprise an open structure to further reduce the weight of the distributor plate 200 and facilitate handling and manipulation to, from and within the rotor 100. Providing a separate spacer plate 207 relative to the attached/bonded work and adapted plates 205, 206 is advantageous for processing of specific materials for example with varying feed size and moisture content. By adjustment of the relative axial position of contact face 216 within rotor 100, by selection of a spacer plate 207 having a predetermined axial thickness (or by omitting spacer plate 207) it is possible to optimize the position of contact face 216 axially between lower and upper discs 102, 101 and in particular the position of contact face 216 relative to wear plates 201 and the carbide tips 209. Accordingly, the service lifetime of wear plates 201 and tips 209 may be enhanced.

FIG. 8 illustrates a further embodiment by which an adhesive may be positioned between bottom 915 of the recess and walls 916 and 917 or the tiles 212 may be arranged on upper surface 914 of work plate 205. Support plate 206 is non-detachably coupled to work plate 205 via mating contact between an upward facing surface 504 and support plate 206 and a downward facing planar surface 505 of work plate 205. According to the specific implementation, plates 205, 206 are glued together via an adhesive. According to further specific implementations, work plates 205, 206 may be coupled via mechanical attachments including for example rivet welding, thermal bonding, or other mechanical attachments such as pins, screws or bolts.

According to further embodiments, tiles 212 may comprise granules, chips or randomly sized pieces of high abrasion resistant material embedded within work plate 205 at work surface 506 to form a single continuous planar surface to define contact face 216.

Referring to FIG. 6, support plate 206 comprises a central bore 701 extending axially through plate 206 between lower and upper faces 503, 504. A corresponding through-bore 700 also extends within lowermost spacer plate 207 between the lower and upper faces 502, 501 to be axially co-aligned with support plate bore 701. Accordingly, distributor plate 200, as shown in FIG. 3, is adapted to be conveniently maneuvered within rotor 100 to be centred onto hub 105. In particular an axially extending locating spindle (not shown) projects axially upward from hub 105 to extend through base plate 408 and to be received within the central bores 700, 701 of plates 207, 206, bores 700, 701 each comprise a single cylindrical surface to sit around the locating spindle when the distributor plate 200 is mounted in position as illustrated in FIGS. 2 to 4. The abutment between bores 700, 701 and the locating spindle does not provide any axial locking of plate 200 at rotor 100 and is adapted to for centring only. As shown in FIG. 4, distributor plate 200 is releasably mounted at rotor 100 and in particular to hub 105 exclusively via the attachment components 208 distributed around the perimeter 301 of plate 200. Such a configuration is advantageous to greatly facilitate mounting and dismounting of the work plate 200 at rotor 100 as personnel need gain access only to the region surrounding plates 200 without being required to assemble plate 200 at a central mounting position within the plate perimeter 301 that is typically required with conventional arrangements. Accordingly, the assembly and dismounting of plate 200 at rotor 100 is time efficient and reduces the crusher downtime during servicing via the crusher inspection hatch. According to specific implementation, a total weight of distributor plate 200 including work plate 205, support plate 206 and spacer plate 207 is in the range 6 to 8 kg. Accordingly, work plate 205, support plate 206 and tiles 212 can be handled conveniently as a unified structure during installation and removal that obviates the need for a modular or segmented construction that would otherwise require assembly at hub 105. Attachment components 208 provide both axial locking of plate 200 onto hub 105 and lock plate 200 rotationally with respect to axis 107.

Referring to FIG. 7, each of the wear plates 901 mounted at upper disc 101 comprise a generally elongate shape profile having a first end 918 and a second end 919. Each plate 901 comprises a dual layer having a lowermost work plate 407 mechanically attached and/or bonded to an axially upper support plate 400. Each plate 407, 400 is substantially planar and non-detachably coupled via mating between the upward facing surface 909 of work plate 407 and downward facing planar surface 910 of support plate 400. The unified assembly of plates 407, 400 is mountable at disc 101 via a mount face 911 of support plate 400 that is forced axially against the disc 101 via the attachment components 401. An uppermost planar surface 908 represents a majority of the contact face of plate 901 over which material is configured to flow on passing through rotor 100. According to the specific implementation, the work plate 407 and support plate 400 may comprise the same constituent materials and relative thicknesses as the work plate 205 and support plate 206 as described with reference to the distributor plate 200 as described before.

To enhance the abrasion wear resistance of each plate 901, abrasion resistant tiles 213, 913 extend a portion of the length of plate 201 between ends 918, 919. Tiles 213, 913 are also arranged to extend in a width wise direction across plate 901 between a curved side edge 906 and a straight side edge 907. In particular tiles 213, 913 are mounted at plate 901 at a position to cover the flow path of material as it is thrown radially outward from central distributor plate 200 through outflow openings 203 corresponding to flow path A, as shown in FIG. 4. Each tile 213, 913, according to the specific implementation, comprises the same abrasion resistant material as distributor plate tiles 212. The mounting of each wear plate tile 213, 913 at wear plate 201 by means of adhesive. The main body of plate 901 comprises predominantly or substantially exclusively a steel alloy. In some embodiment, main body of plate 901 comprises nodular iron.

Each one of the tiles 213 and 913 has a shape of hexagon or half-hexagon as an isosceles trapezoid. The tiles 213 and 913 are arranged in the lower surface 908 of the main body such that the combination of the tiles 213 and 913 forms a continuous working area 912 being encompassed by the lower surface 908 of the main body. The tiles 213 and 913 are arranged and positioned against each other, and as shown in FIG. 7, tile 213 and 913 each has three edges each matching and positioned against an edge of a neighbouring tile. Each of the three edges is positioned in the same direction with an edge of a neighbouring tile, having the same length, and being placed very closely to the edge of the neighbouring tile. People of ordinary skill in the art should understand that there might be tiny gap between one of the three edges and the edge of the neighbouring tile, and the gap will be filled and strengthened with the adhesive that is used to glue tiles 213 and 913 to the work plate 205.

At the mid area of the working area 912, only regular hexagon shaped tiles 914 are arranged and positioned one by one such that each tile 914 has six edges each matching and positioned against an edge of a neighbouring tile. Through such an arrangement, each tile 914 at the mid area can have maximum six neighbouring tiles to bear and disperse the impact press imposed by the material. At the outer most lap of the working area 912, hexagon or half-hexagon shaped tiles 213 and 913 are arranged and positioned one after another such that the continuous working area 912 has a contour shape of a rectangle with two longer sides being parallel and two shorter sides being parallel and where two of the corners being diagonally opposed to each other are truncated. These two truncated corners are adapted to the hexagonal shape of the tiles.

The working area 912 is positioned such that the two shorter sides of the rectangle is parallel with an edge of the rear end 919 of the main body of the upper wear plate 901, the two longer sides of the rectangle is parallel with the straight side 907 of the main body and the longer side is arranged on a distance from the straight side 907 of the main body. In such a way, the shape of the mainly rectangle working area 912 can cover most variants of path A, as shown in FIG. 4, in case of the volume and area of bed of material changes due to different operating conditions and different materials.

1. An abrasion wear resistant plate mountable to a rotor of a vertical shaft impact crusher, the abrasion wear resistant plate comprising:
a metallic main body; and
at least four non-metallic tiles arranged on an upper surface of the main body to form a portion of a contact face facing an internal space of the rotor, each one of the tiles having an abrasion wear resistance greater than that of the main body, wherein each one of the at least four tiles has at least three edges each matching with and positioned against an edge of a neighbouring tile.

2. The plate as claimed in claim 1, wherein the at least four tiles are arranged in the upper surface of the main body such that a combination of the at least four tiles forms a continuous working area at the upper surface of the main body.

3. The plate according to claim 1, wherein the main body comprises a steel alloy.

4. The plate according to claim 1, wherein the main body comprises nodular iron.

5. The plate as claimed in claim 1, wherein the at least four tiles comprises at least one tile having six edges each matching with and positioned against an edge of a neighbouring tile.

6. The plate as claimed in claim 1, wherein each one of the at least four tiles has a shape of a hexagon or a half-hexagon.

7. The plate as claimed in claim 1, wherein the main body has an elongate shape, a front end pointing towards a rotating direction of the rotor and a rear end positioned at an opposite side, the working area being located closely to the rear end of the main body.

8. The plate as claimed in claim 1, wherein the continuous working area has a peripheral being mainly rectangularly shaped with two longer sides being parallel.

9. The plate as claimed in any of claim 1, wherein the main body has a straight side and a curved side, the continuous working area being positioned such that the two longer sides rectangle are parallel with the straight side.

10. The plate as claimed in claim 1, wherein the contact face is substantially planar.

11. The plate as claimed in claim 1, wherein the at least four tiles comprise any one or a combination of aluminium oxide (alumina), zirconium oxide (zirconia), silicon carbide, boron carbide, silicon nitride or boron nitride.

12. The plate as claimed in claim 1, wherein the at least four tiles are bonded to the main body via an adhesive.

13. The plate as claimed in claim 1, wherein the main body includes a work plate, the at least four tiles being mounted on the work plate, and a support plate non-detachably coupled to the work plate.

14. The plate according to claim 10, wherein the continuous working area is smaller than a surface area of the main body of the contact face.
